(19) United States
(12) Patent Application Publication
(10) Pub. No.: US 2015/0139469 A1
(43) Pub. Date: May 21, 2015

(54) Secure Storage Device for Wireless Headsets

(71) Applicant: Innervoice Innovations Inc., San Jose, CA (US)

(72) Inventor: David R. Hurwitz, San Jose, CA (US)

(21) Appl. No.: 14/543,814

(22) Filed: Nov. 17, 2014

Related U.S. Application Data
(60) Provisional application No. 61/904,683, filed on Nov. 15, 2013.

(51) Int. Cl. H04R 1/02

(52) U.S. Cl. CPC H04R 1/02
USPC 381/370

(57) ABSTRACT

Devices and methods for ergonomically, quickly and securely carrying headsets, other wearable items, or other items that must remain handy. In an embodiment, there is a headset carrying device comprising a body for receiving a headset, supporting and protecting the majority of the headset body (boom); a capture clip for retaining the earpiece of the headset; and a mounting device for affixing the headset carrying device body to the user or an object. The capture clip holds the headset near the earpiece, allowing for easy and secure capture, followed by easily accomplished intentional release. The capture clip may be a removable component to accommodate various types of headset designs and sizes and formed into the body without moving parts, or alternatively comprises a mechanism with moving parts.

### CROSS-REFERENCE TO RELATED APPLICATION

This application claims priority to U.S. provisional patent application Ser. No. 61/904,683, filed on Nov. 15, 2013, which is hereby incorporated by reference in its entirety.

### BACKGROUND OF THE INVENTION

1. Field of Invention

The present invention is related to the field of mechanical devices and manufactured articles. More particular, the present invention relates to secure storage of wireless devices and other items.

2. Background

In particular, wireless headsets are small devices that must be kept on or near a user at all times. However, headsets tend to get misplaced in the moment or lost altogether. This is especially a problem for users who do not consistently wear the headset and prefer to take it off when not in use. Thus, due to the difficulty in unconsciously manipulating a headset when needed, most people do not use headsets or become frustrated. Unconscious use requires that headsets be readily and assuredly at hand.

There are surprisingly few wireless headset storage devices. However those that do exist lack the combination of confident security and unconscious ease-of-use when it comes time to don and doff the headset. Other wireless headset storage devices do not work well because they are not designed to allow immediate access and storage of the headset, not designed to be affixed to the wide variety of on- and off-person locations necessary for use in the field, not designed to accept a variety of headsets, and lack the necessary combination of secure storage and ready access.

Further problems in existing devices include a failure in ergonomics and the ability for one-handed manipulation to securely dock the headset or easily retrieve the headset. Further drawbacks in current devices include the resulting exposure of the headset outside the carrying device which can lead to inadvertent dislodgement and damage to the headset.

As such, a need exists for a secure and convenient device for carrying wireless headsets and other handy devices or instruments, which provides for an ergonomic and unconscious user experience.

### SUMMARY OF THE INVENTION

An object of the invention is to provide a convenient headset carrying device having a unique combination of headset capture/retention by way of a headset capture clip with a wearable or near-body mounting means. In other embodiments, the carrying device is configured to secure/holster other objects for convenient and instant access. Embodiments of the present invention allow for unique ease-of-use and provide the confident security required for all-day active usage of headsets or other items.

Another object of the invention is immediate access and storage of the headset. This supports the unconscious ease-of-use people expect when answering or concluding a call, or when performing other audio interactions involving their headsets, such as listening to music or audio books.

Another aspect of the invention is the design of the device with mounting means allowing for the device to be affixed to a wide variety of on- and off-person locations necessary for use in the field. These include but are not limited to belts, waistbands, hand bags, straps, shirts, automobile cockpit surfaces, desktop surfaces, and other objects.

Embodiments of the invention provide a device with a housing configured to accept a variety of headsets interchangeably. According to an embodiment, the headset capture clip is removably attached to the housing so as to accommodate a variety of capture clip styles and sizes interchangeably with the same housing of the device. In other embodiments, the capture clip contact surface is formed to accommodate multiple headset designs and sizes, regardless of the removability of the capture clip from the housing.

Other embodiments of the capture clip may accommodate items other than headsets which have contact surfaces that correspondingly engage securely with the capture clip contact surface. Examples of other items include remote control “clickers”, such as for a TV, audio system or that a presenter might use to advance a slide show. Yet another example includes medical instruments that a health care provider may frequently use while moving about a clinic.

In another aspect, the invention provides the secure storage that people require so there is no concern or worry about where the headset is at all times. The device is further configured for an active lifestyle, keeping the headset securely in place and readily available, even when hiking or engaging in other vigorous activity.

According to an embodiment of the present invention, there is a headset carrying device comprising a housing body for supporting a capture clip and configured to have a mounting device. The capture clip both guides and retains the headset within the housing, allowing for easy and secure capture, followed by easily accomplished intentional release. In an embodiment, the capture clip retains the headset by the earpiece and in another embodiment at the barrel of the earpiece. The capture clip can be a removable component from the housing and interchangeable with different sized configurations to accommodate the size of a variety of headsets and other items. The capture clip is in another embodiment formed into the housing body without moving parts. Alternatively in another embodiment, the capture clip is a mechanism with moving parts.

The mounting device is either integrated with the housing or affixed to the housing, removably attaches the housing to the user or to a nearby location, or object, e.g., in a car or accessory. The mounting device or mechanism can be any mounting means including but not limited to a clip, a suction cup, a clamp, magnetic connection, hooks, adhesives, swivel connection, snap connection, button connection, bracelets, or various alternative embodiments. The attachment means can mount/clip to a belt, waistband or a wide variety of personal and near-person mounts.

In an aspect of the present invention, the device is envisioned to have a housing body and capture clip that is configured to securely holster/retain a variety of wearable devices, instruments or tools, regardless of wireless capability, and which are frequently retrieved by the user during use but preferably conveniently housed on or close to the user when not in use, to be readily retrievable. In a particular embodiment, the housing has a receptacle with an inner surface configured to support a longest dimension of an object, having an open receiving port on a first end of the housing, a second end opposite the first end, and a wall forming the exterior of the housing, extending from the inner surface and running a part of the front of the housing, around to a rear of the housing; and a capture clip positioned inside the housing to protrude from the inner surface and configured to removably secure a component of the object.

Moreover, in embodiments of the present invention, a segment of the housing is configured to be removable from the housing and thereby interchangeable with other segments. The interchangeability in the removable segments allow for aesthetic design, informative, indicative or advertisement appearance changes to the housing to accommodate a variety of user desires and needs. The segments may be provided, for example, with various different colors, designs, textures, materials and surface applications.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a front view of the device with capture clip engaged, according to an embodiment of the present invention.

FIG. 2 is a left side view of the device with capture clip engaged, according to an embodiment of the present invention.

FIG. 3 is a rear view of the device with capture clip engaged, according to an embodiment of the present invention.

FIG. 4. is a right side view of the device with capture clip engaged, according to an embodiment of the present invention.

FIG. 5 is a top perspective view of the device with capture clip engaged, according to an embodiment of the present invention.

FIG. 6 is a bottom perspective view of the device with capture clip engaged, according to an embodiment of the present invention.

FIG. 7 is a top view of the device with capture clip engaged, according to an embodiment of the present invention.

FIG. 8 is a bottom view of the device with capture clip engaged, according to an embodiment of the present invention.

FIG. 9 is an exploded view of the device with the cover removed, according to an embodiment of the present invention.

FIG. 10 is a cross-sectional view from the right side of the device in FIG. 4, with capture clip engaged, according to an embodiment of the present invention.

FIG. 11 is an exploded view perspective view of the device, according to an embodiment of the present invention.

FIG. 12 is front view of a capture clip, according to an embodiment of the present invention.

FIG. 13 is a side view of the capture clip in FIG. 12, according to an embodiment of the present invention.

FIG. 14 is a front view of a capture clip according to another embodiment of the present invention.

FIG. 15 is a front view of capture clip according to another embodiment of the present invention.

FIGS. 16 and 17 are left and right side views of the capture clip of FIG. 15, according to an embodiment of the present invention.

FIG. 18 is a perspective view of the capture clip of FIG. 15, according to an embodiment of the present invention.

FIG. 19 is a front view of the device with the capture clip of FIG. 15 engaged, according to an embodiment of the present invention.

FIG. 20 is a right side view of the device with the capture clip of FIG. 15 engaged, according to an embodiment of the present invention.

FIG. 21 is a top view of the device with the capture clip of FIG. 15 engaged, according to an embodiment of the present invention.

FIG. 22 is a perspective view of the device with the capture clip of FIG. 15 engaged, according to an embodiment of the present invention.

FIG. 23 illustrates the insertion or removal of the capture clip to the housing of the device, according to an embodiment of the present invention.

FIG. 24 illustrates the device with insertion or removal of a headset, according to an embodiment of the present invention.

FIG. 25 illustrates the device with a headset engaged, according to an embodiment of the present invention.

FIG. 26 illustrates the interchangeability of a removable housing cover, according to an embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

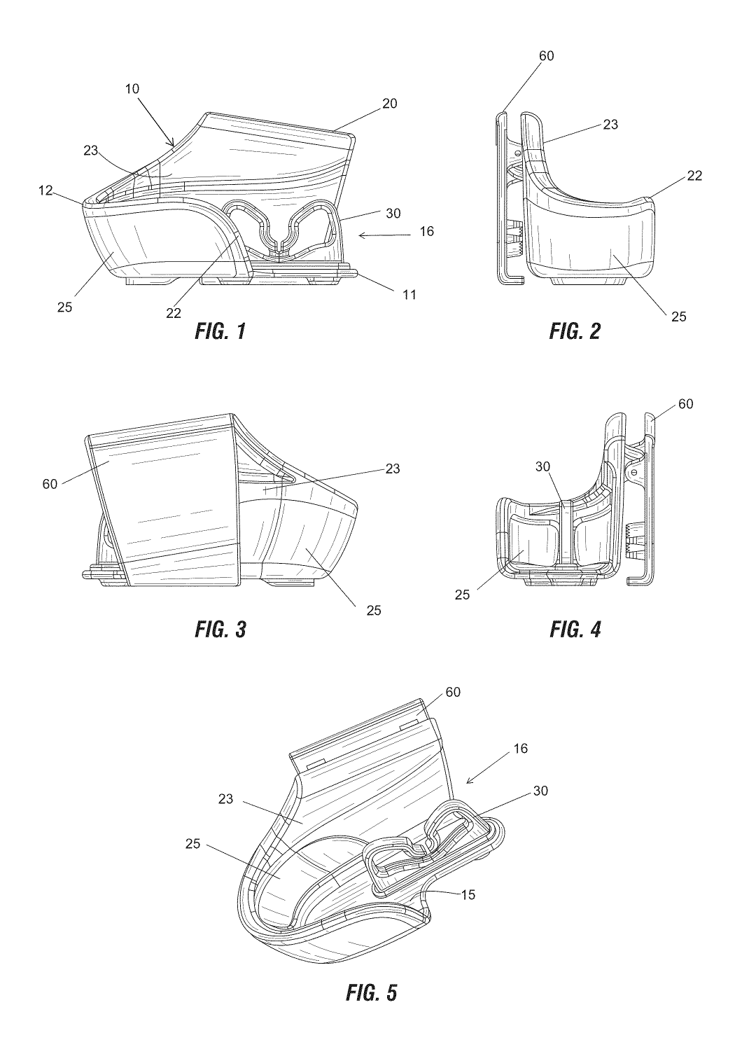

Referring now to FIGS. 1-9, there is illustrated the device 10 according to an embodiment of the present invention. Embodiments of the present invention provide a secure and convenient home for wireless headsets when they are not in use. The embodiments accomplish this by the unique combination of two physical restraint mechanisms. As shown in FIGS. 1-5, the device 10 comprises a housing 20 servicing as a holster for the headset, the housing/holster having a receptacle for placing the headset in a protected and supportive manner. The housing 20 comprises a first end 11 and an opposing second end 12. At the first end 11, an open entry/receiving port 16 is provided. The housing further comprises a wall running from the front 22 of the housing to the rear 23 of the housing whereby a majority of a headset body would be enclosed when secured in the formed receptacle of the housing. A capture clip 30 secures, retains and guides the headset in a smooth and unconsciously easy way, likewise allowing for unconsciously easy removal of the headset when it is needed for use. As shown in FIG. 5, the capture clip 30 protrudes from an inner surface 15 of the housing 20. A mounting means 60 secures the carrying device to the user or to a handy location or object nearby. In an embodiment, the mounting means is a clip 60 positioned on the rear 23 surface of the housing.

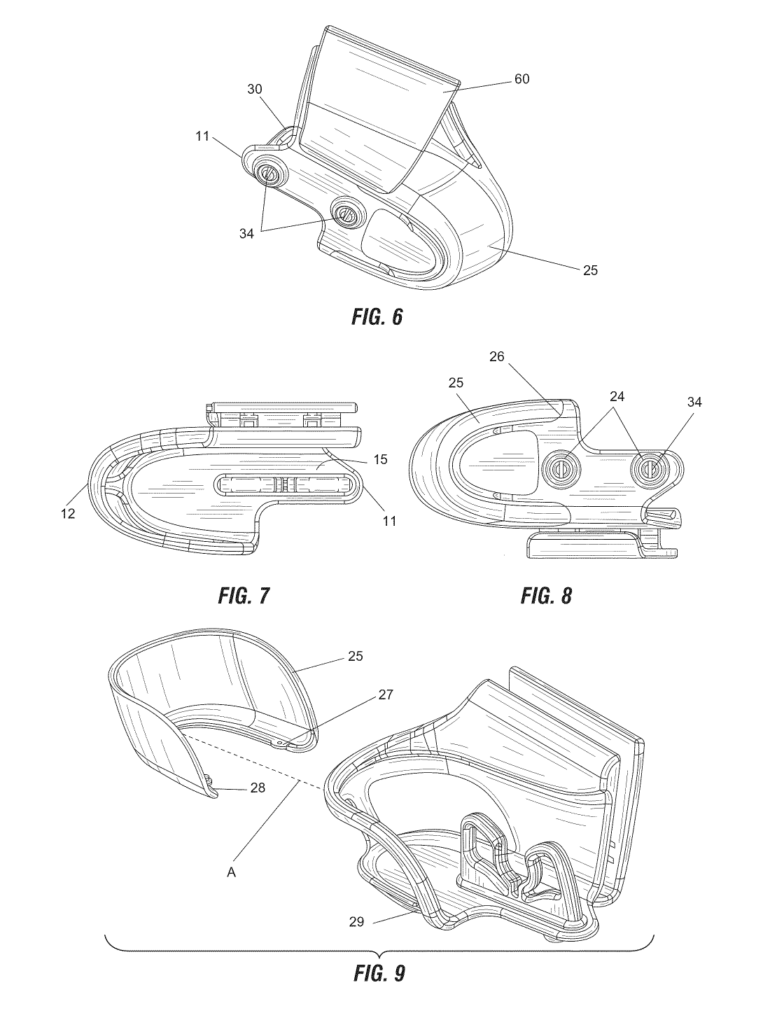

As shown in FIGS. 6 and 8, the capture clip 30 is attached to the inner surface 15 of the receptacle by way of a pin and aperture connection according to an embodiment of the present invention. A pair of pins or posts 34 protrudes from the bottom of the capture clip 30 and engages with a corresponding pair of apertures 24 on the housing bottom. In such a configuration, the capture clip 30 is securely in place when in use but may be removable from the housing by push/pressure.

As shown in FIG. 9, the device comprises a removable segment or cover 25 of the housing that is formed as part of the housing wall, according to an embodiment of the present invention. The cover 25 slidingly connects to the housing about a horizontal plane A, and along a pair of corresponding tracks 28 and 29 which are located on the cover and the housing respectively. A pair of catches 27 are further provided to securely snap fit the cover 25 in place with the housing, yet allowing release of the cover 25 with pinch pressure when time to change out or remove the cover 25 as desired.

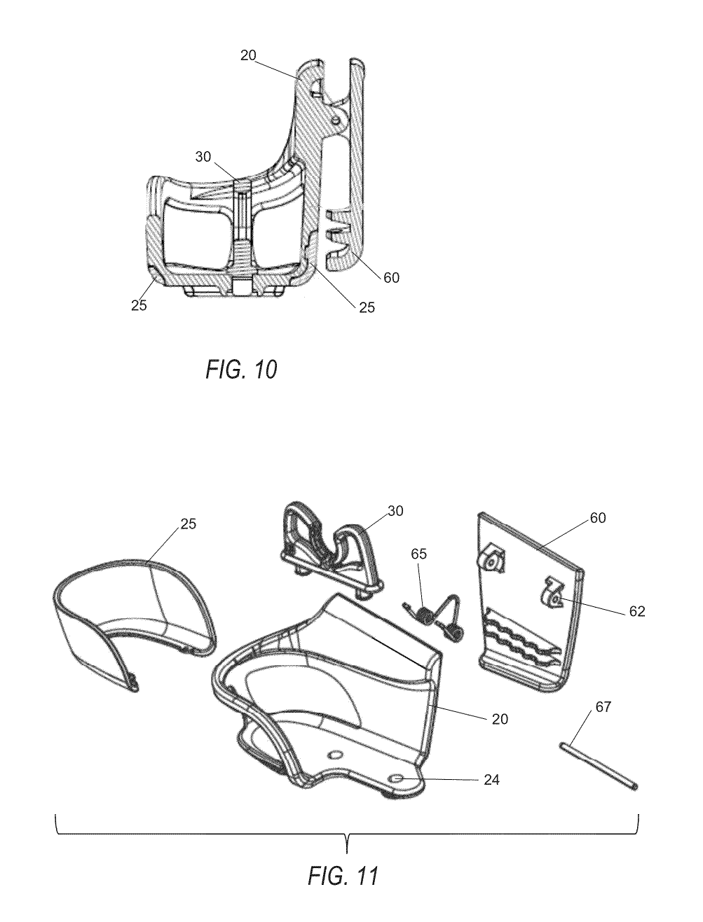

FIGS. 10-11, illustrating a cross-sectional view and exploded view respectively, further show the components of the carrying device in further detail. FIG. 10 shows the cross-sectional view from the right side at a cutaway through the capture clip 30, segment cover 25, mount 60, and housing 20 as shown. FIG. 11 illustrates an embodiment in exploded view in which the mounting means 60 is a spring clip attachment to the rear of the housing of the device. A spring 65 with pin 67 engaged through the receiving holes 62 of the clip 60 are shown.

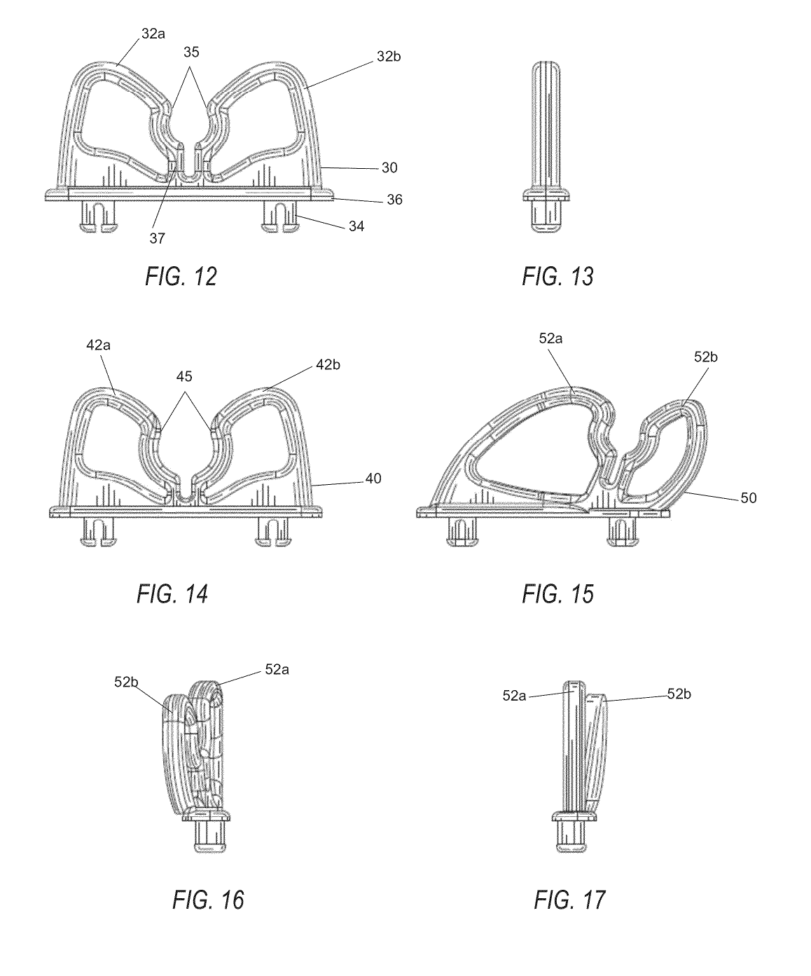

As illustrated in FIGS. 12 and 13, there is an embodiment of the capture clip 30 alone. In this embodiment, the winged components 32a, 32b of the capture clip have a symmetrical configuration. The components provide a flexibility such that when the barrel of the earpiece is inserted, the winged components separate enough at a throat 35 terminating at vertical stems 37, to receive and contact the barrel smoothly yet have the tension to maintain the earpiece in a secure manner and allow for smooth release when needed. The capture clip is positioned on the inner surface 15 of the housing such that the base 36 of the capture clip resides flush upon the inner surface whereby the posts 34 are engaged in the housing apertures 24.

FIG. 14 shows another embodiment of the capture clip 40 to accommodate a headset having a slightly different barrel diameter. This embodiment further has symmetrical winged components 42a and 42b. The throat 45 has a different diameter than in the capture clip 30 of FIG. 12.

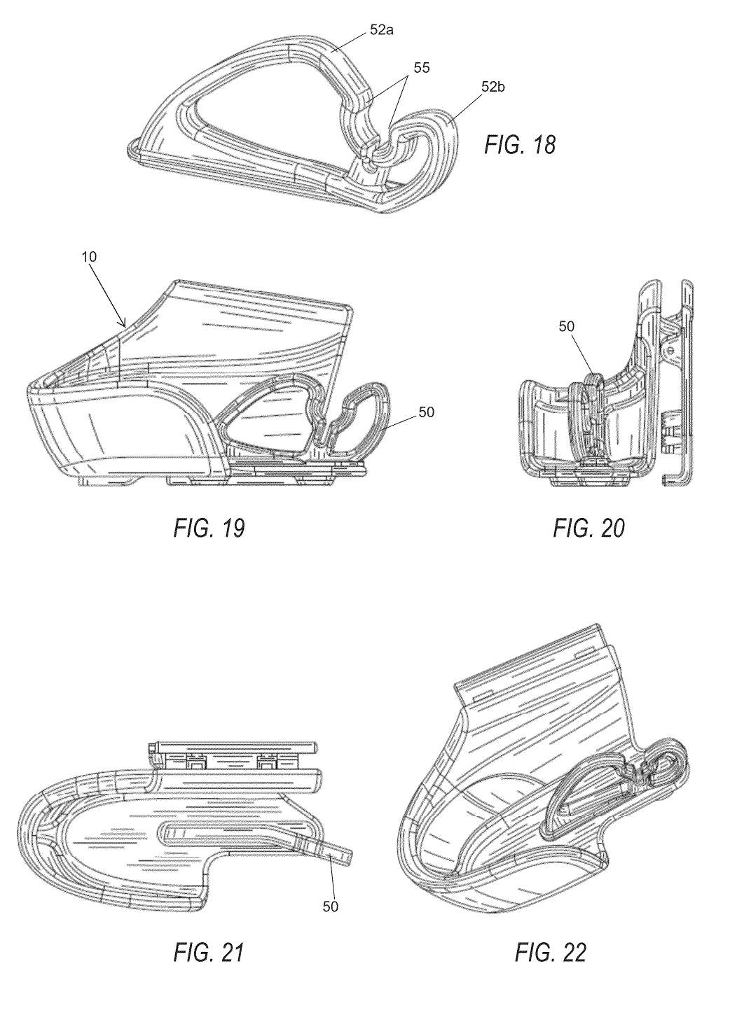

Other embodiments are possible, including a capture clip 50 to accommodate carrying a headset of different dimensions. As shown in FIGS. 15-18, an example of an asymmetrically configured capture clip 50 may be used. The winged components 52a and 52b are both asymmetrical and offset from a plane as shown in the side views of FIGS. 16 and 17. The capture clip 50 further has a throat 55 configured to securely capture the barrel of an earpiece. The embodiment of this capture clip 50 is further illustrated as engaged with the housing of the device in FIGS. 19-22.

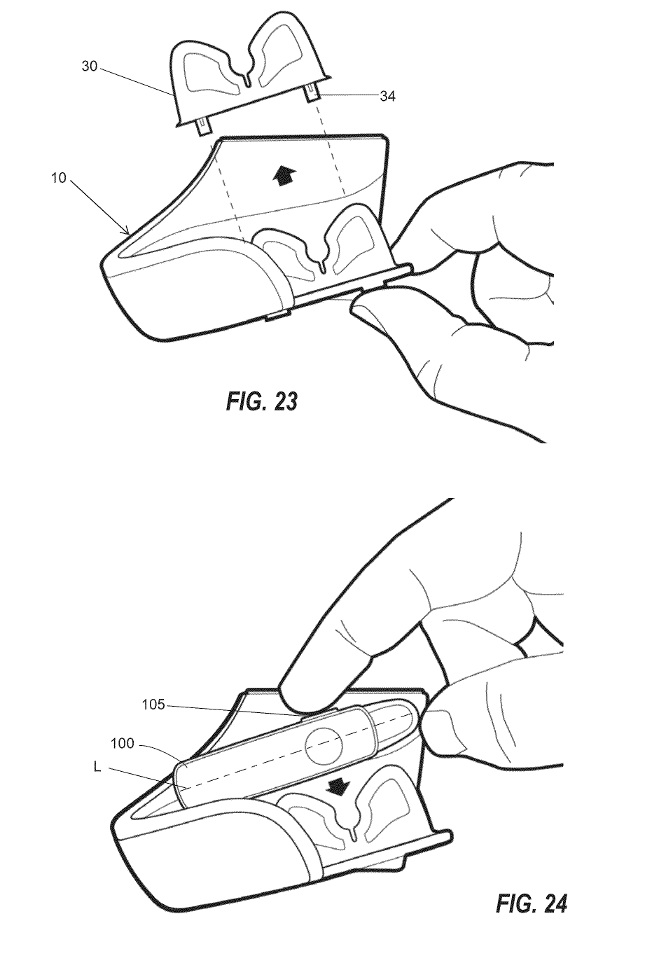

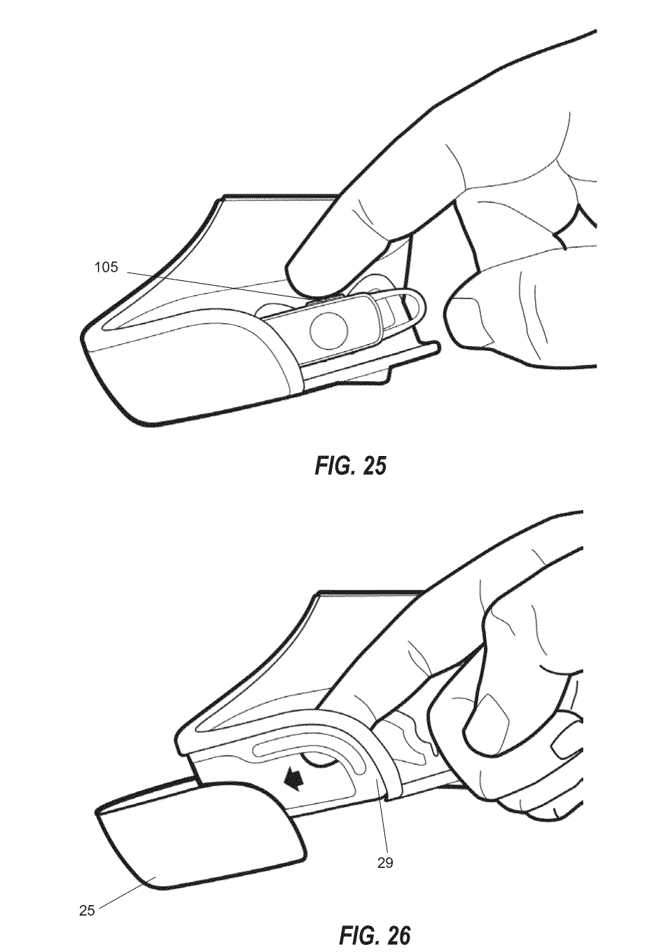

Each of the capture clips may be constructed as an integrated part of the housing but is also envisioned to be a removable element. See FIG. 23 for an example of the capture clip 30 being inserted and removed from the housing of the device 10. The removable capture clip allows for easy accommodation to a wide variety of headset designs. At the base 36 of the capture clip is a connection means such as one or more posts 34 which can snap fit into corresponding receiving apertures 24 at the base of the housing for a secure yet releasable hold. Positioning of the capture clip is preferably at a distance in the receptacle of the housing such that the boom 100 of the headset rests in a protected manner inside the housing, without much exposure. In an embodiment, the capture clip resides at a distance away from both the front 22 and rear 23 wall of the housing, and closer to a first end 11 of the housing. A majority of the headset or object is protected when engaged in the receptacle of the housing. As shown in the embodiments of FIG. 24 and FIG. 25, the inner surface 15 supports a longest dimension L of the headset 100 and the capture clip secures the barrel of the earpiece 105.

According to an embodiment of the present invention, the device can be used singly, as with conversational/telephone headsets. It can also be used in pairs for use with stereo headsets.

Using the mounting device or means, the invention is mounted onto or near the person, such as onto a belt, handbag, cuff, wrist, strap or nearby surface/object.

According to a method of using the device of the present invention, when a call comes in or the user wants to make a call or otherwise use their headset, the user gives a gentle tug on the headset, releasing it from the invention and allowing it to be naturally swept up to the ear, where it can be turned on via controls built into every headset. The device provides for an ergonomic experience in donning of the headset. See further FIG. 24 showing an embodiment of the present invention.

Upon finishing a call or otherwise being done with using the headset, the user removes/doffs the headset from their ear and naturally drops their hand to the invention, where the headset smoothly slides into the capture clip at the earpiece 105, securing the headset into place. See further FIG. 25 showing an embodiment of the present invention. Tactile feedback is provided to assure the user that the headset is securely stored.

According to a method of manufacturing the device, the body housing is configured so that a capture clip is contained to be removable and is connecting to or otherwise formed with a mounting device. The capture clip securely captures and holds a headset, signaling to the user that their headset is securely in place. The capture clip also easily releases the headset when appropriately tugged or otherwise properly released by the user.

The invention can be made by forming a durable material into the body housing and affixing it to a mounting device. The capture clip can be formed into the body or assembled into it. The device may comprise a variety of materials including plastics, composites, metals and combinations thereof. According to an embodiment, an acrylonitrile butadiene styrene (ABS) material is used for the body and may incorporate a single or combinations of thermoplastics, polymers/resins including steel or other material inserts where needed for added rigidity while maintaining a flexibility in the capture clip to easily receive the earpiece of the headset. The mounting means may further comprise an ABS material. In a further embodiment, the capture clip comprises Styrene-Butadiene Copolymers (SBC). The SBC material provides for a built-in flex to the winged components. As noted, the material has a flexibility at the top with a built in rigidity. In an embodiment, the bowing out feature provides additional flex as opposed to an equal dimensioned winged component. In other embodiments, the capture clip is formed with a floating throat where the base of the curve at the throat would not have any vertical stems.

The capture clip can be a no-moving-part mechanism or can have moving parts. Such moving parts may entail a moving lock mechanism and spring loaded type release/button. The use of moving parts can offer greater security and flexibility for fitting various headset designs. The capture clip may be removable or in other embodiments, formed as an integrated part of the housing.

The mounting device can employ a clip, suction cup, spring or other method of mounting the invention. The mounting device comprises any mounting means including but not limited to a clip, a suction cup, a clamp, magnetic connection, swivel connection, clasps, snap connection, button connection, hooks, adhesives, or various alternative embodiments. The clip embodiment can clip on a belt, waistband or a wide variety of personal and near-person mounts. The device can move between multiple mounting means, e.g., detaching from a belt clip and attaching to a suction cup, which is useful when getting ready to drive.

Another alternative mounting means is a wristwatch, bracelet, armband, bands, or other wearable item. This not only makes the headset literally handy, it can combine with a smart watch or other smart device to function as a wearable computing system.

Moreover, the invention can be used in pairs or expanded to hold two headsets, useful for listening in stereo. The receptacle of the housing would be sized to accommodate a pair of headsets side by side. The capture clips may reside in an offset manner inside the housing.

As in all embodiments, the body or boom of the headset is in a protected position, provided with horizontal support relative to a horizontal plane of the headset, supporting the longest dimension L of the headset. The positioning of the headset may be positioned at any angle relative to the desired positioning of the device when attached. The body of the headset will remain in a protected condition when engaged with the device. In an embodiment, the mounting means includes a swivel such that the device housing may be adjusted to any position or angle as desired, while the mounting surface remains constant.

Various mounting entry points to the capture clip are envisioned, for example as shown in the embodiments of the drawings, from top down entry, but may also include a capture clip configured for side entry. For example, the capture clip may be rotated 45 degrees clockwise. The side entry retaining position essentially allows the headset to be inserted at the distal end of the boom into the receptacle such that the capture clip components reside above and below the earpiece barrel. This embodiment naturally requires the bottom facing wing of the capture clip to have a much shorter profile so that the body/boom rests along the surface of the receptacle. The bottom facing wing of the capture clip would also be structured to have a connection point to the inner surface of the housing. Various capture clip retaining positions are contemplated and may further be interchangeably used with the housing of the device.

As discussed above, the end cover is removable for interchangeability with a variety of colors or possible surface designs to accommodate the tastes of the user. This cover, or segment of the housing, can be removed at a variety of locations of the housing, including portions of the front and rear of the housing. See FIG. 26 showing the removal of the cover according to an embodiment of the present invention. In an embodiment as shown, the cover 25 slides out from the housing end along a track. The catches on each side of the track snap into the housing in corresponding locations. Such interchangeability allows for flexibility in daily use of the device, to accommodate and appeal the different aesthetics of users or for use in various settings and events, for example, professional, sporting, leisure, marketing purposes etc. The removability of the cover still allows for the housing to function with or without the cover.

In an embodiment of the present invention, there is an interchangeable housing cover 25 configured for use with a housing of a carrying device. The housing cover 25 comprises a partial segment of the overall housing surface. On the inside surface of the cover at a distance along the at least part of the periphery of the cover, there is a track 28 to correspond with the track 29 on the housing periphery. A snap/catch connection 27 on each side of the cover 25 may further facilitate connection to the housing. In other embodiments, the housing cover may be an additional sleeve placed over or on a housing of a carrying device. Connection or attachment to the housing can be attained by a variety of means such as snap connection, sliding track connection, adhesives, clips or other fastening means.

In a further embodiment of the present invention, there is a capture clip that is configured to hold a headset or other rapidly accessible object, for example a medical instrument, and which is attached to a holster/housing in a manner wherein the headset is protected along the majority of the headset outer surface within the holster. The capture clip retains the headset at a barrel of the headset earpiece such that the capture clip contacts the barrel on at least two tensioned contact points. Release of the headset is accomplished by pressure applied to separate the capture clip contact points away from the barrel. Alternatively, the capture clip retains an instrument about a component of the instrument, the component slides between the capture clip contact points similarly as would a barrel of a headset earpiece. Release of the instrument for instant access by the user would be similarly achieved by applying pressure to the separate the capture clip contact points away from the component of the instrument. Examples of other devices/items/instruments contemplated for use include remote control “clickers”, such as for a TV, audio system or to control an audio-visual presentation. Yet another example includes medical instruments that a health care provider may frequently use while moving about a clinic.

The wireless headset devices contemplated for use with the carrying device include a variety of devices having wireless communication capabilities, for example and not limited to mobile phone and computing technology, Wi-Fi, Bluetooth, cellular, short-range, cordless, and other wireless sensor or wireless networks.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description.

What is claimed is:

1. A carrying device comprising:
a housing having a receptacle with an inner surface configured to support a longest dimension of an object, having
an open receiving port on a first end of the housing,
a second end opposite the first end, and
a wall forming the exterior of the housing, extending from the inner surface and running from a front of the housing, around the second end, to a rear of the housing; and
a capture clip positioned inside the housing to protrude from the inner surface and configured to removably secure a component of the object.

2. The device according to claim 1, where the open receiving port has a length at least that of the longest dimension of the object.

3. The device according to claim 1, wherein the housing is configured to surround a majority of the outer surface of the object.

4. The device according to claim 1, wherein the wall of the housing comprises a removable segment at the second end of the housing.

5. The device according to claim 1, wherein the capture clip protrudes from the inner surface at a distance away from the wall from both the front and rear of the housing.

6. The device according to claim 1, where the capture clip has a higher flexibility than a flexibility of the housing.

7. The device according to claim 1, wherein the capture clip comprises a pair of flexibly tensioned wing components located symmetrically on each side of a center of the capture clip.

8. The device according to claim 1, wherein the capture clip comprises a pair of flexibly tensioned wing components located asymmetrically on each side of a center of the capture clip.

9. The device according to claim 8, wherein a first wing component curves out from a plane of a second wing component.

10. The device according to claim 1, wherein the capture clip is removably attached to the receptacle.

11. The device according to claim 10, wherein the capture clip is removably attached to the receptacle by a pin and aperture connection.

12. The device according to claim 11, wherein the pin and aperture connection comprises pins extending from an underside of the capture clip to engage apertures on the inner surface of the receptacle.

13. The device according to claim 1, wherein the housing comprises an attachment mount for removably attaching the device.

14. The device according to claim 13, wherein the attachment mount is positioned on a rear surface of the housing.

15. The device according to claim 14, wherein the attachment mount comprises a clip.

16. A headset carrying device comprising:
a housing having a planar inner surface configured to support a headset body, having an exposed top region and an exposed first end of the housing,
a contained second end,
a wall forming the exterior of the housing, extending from the inner surface and running from a front of the housing, around the second end, to a rear of the housing;
a retainer positioned inside the housing configured to removably receive a barrel of the headset which connects the earpiece and the body of the headset; and
an attachment mechanism located on the exterior of the housing.

17. The device according to claim 16, wherein the first end is closest to the earpiece of an inserted headset, and the second end is closest to an end of the body of the headset opposite the earpiece.

18. The device according to claim 16, wherein the retainer is attached to the planar surface between the rear and the front of the housing at a distance away from the wall.

19. The device according to claim 16, wherein the retainer is located on the planar surface closer to the first end.

20. The device according to claim 16, wherein the retainer comprises a pair of tensioned components, the retainer configured to receive insertion of the earpiece barrel between the pair of tensioned components such that the earpiece faces the rear of the housing and a majority of a longest dimension of the body of the headset rests along the planar surface inside the housing.
